(19) United States
(12) Patent Application Publication
(10) Pub. No.: US 2005/0003070 A1
(43) Pub. Date: Jan. 6, 2005

(54) Shelf stable vitamin C in oatmeal products

(76) Inventors: David V. Foster, Mt. Prospect, IL (US); Christine R. Peters, Cary, IL (US); John J. Smith, Hoffman Estates, IL (US)

Correspondence Address: Cook, Alex, McFarron, Manzo, Cummings, & Mehler, Suite 2850, 200 West Adams, Chicago, IL, 60606, US

(21) Appl. No.: 10/613,861

(22) Filed: Jul. 3, 2003

(51) Int. Cl. A23L 1/168

(52) U.S. Cl. 426/619

(57) ABSTRACT

The present invention discloses novel oatmeal compositions. These compositions may be used to provide enhanced nutrition through vitamin fortification which can withstand long periods of storage without any substantial degradation of the incorporated vitamin. The compositions comprise processed oats and a triple encapsulated vitamin C component and may further include sugar, salt, binding agent or texture modifying agent, flavorings, inclusion pieces and a vitamin and mineral blend.

### BACKGROUND OF THE INVENTION

The present invention relates to vitamin fortification of food products and more particularly to shelf stable vitamin C fortified oatmeal products.

The use of vitamins as an ingredient for the fortification of food products is well known. However, the addition of vitamins, particularly water-soluble vitamins such as vitamin C in foods have presented several obstacles. A significant obstacle is the difficulty in maintaining the stability of the vitamin over time after it has been incorporated in the food product. Economic and commercial realities require that any vitamins contained in the food product remain active for extended periods of time while stored in warehouses or sitting on store shelves until purchased and consumed by the public.

The storage environment contributes to the degrading of the vitamins, especially vitamin C. For example, atmospheric oxygen and moisture can cause degradation through the oxidative process. Furthermore, depending on the type of food used, naturally occurring chemicals or enzymes can further increase the rate of degradation. For example, the high moisture content, water activity, and enzymes in oatmeal cause significant loss of the added vitamin C.

Another problem in fortifying foods with vitamins is to do so without changing the flavor profile of the food. The vitamin itself may provide off-flavors. In addition, the solution to one problem such as stabilizing the vitamin to withstand degradation may itself change the sensory or flavor profile of the food product. Optimally, the solution to providing a shelf stable vitamin in food products would also not detract from the target sensory profile or otherwise affect the character of the food product other than its vitamin content. It is desirable that any vitamin C inclusion does not impart a significant off-flavor to the food.

One attempt at a possible solution has been to over fortify the food product. With this proposal, even though some vitamin degradation occurs, enough of the vitamin would remain active in order to provide an effective allowance of the vitamin. However, this solution suffers from the above-mentioned problem of changing the flavor profile, especially with regard to the strong taste exhibited by some vitamin C compounds such as ascorbic acid.

Another possible solution would involve encapsulating the vitamin either in a plasticizable matrix or a glassy carbohydrate matrix. However, these forms of encapsulation methods have their own drawbacks. For example, encapsulation using a plasticizable matrix generally results in a chewy or rubbery texture. Undesirable sensory and flavor attributes typically are imparted. On the other hand, glassy carbohydrate encapsulations may not sufficiently protect the underlying vitamin component since the encapsulation matrix may itself be susceptible to moisture and oxygen degradation. Similarly, they also can impart undesirable texture and sensory attributes.

Therefore it is a general object of this invention to provide an oatmeal product containing a vitamin C component which is shelf stable in the product.

A further object of this invention is to provide an oatmeal product which incorporates a shelf stable vitamin C component without changing the flavor profile of the oatmeal product.

Another object of the present invention is to provide a vitamin C fortified oatmeal product that retains its fortification over time without substantially altering flavor, texture or other sensory properties.

### SUMMARY OF THE INVENTION

The present invention relates to oatmeal composition comprising: an oatmeal component having from about 50% to about 100% by weight of processed oats based on the total weight of the oatmeal component; and a vitamin C component having from about 6 mg to about 1000 mg of a triple encapsulated vitamin C component selected from the group consisting of triple encapsulated ascorbic acid and triple encapsulated salts of ascorbic acid.

The oatmeal component of the oatmeal composition also may include additives such as, from about 0% to about 35% by weight of a sweetener, preferably sugar; from about 0% to about 5% by weight of a salt; from about 0% to about 5% by weight of a flavoring; from about 0% to about 5% by weight of a binding agent or texture modifying agent, preferably guar gum; from about 0% to about 25% by weight of inclusion pieces; and from about 0% to about 5% by weight of a vitamin and mineral blend, each % by weight being based on the total weight of the oatmeal component. One or more different varieties of none, some or all of these additives are possible.

### DETAILED DESCRIPTION OF THE INVENTION

The oatmeal product of the present invention incorporates a triple encapsulated vitamin C component which retains its activity over long storage periods within the oatmeal product. In addition, the oatmeal product does not exhibit adverse off-flavors. The triple encapsulated vitamin C component does not seriously impact the desirable sensory attributes of the oatmeal product, which negative effects are exhibited by the addition of significant amounts of other vitamin C sources.

The oatmeal product can contain a variety of additional ingredients to satisfy diverse consumer preferences. The oatmeal product also can take several forms such as traditional hot oatmeal cereals and so-called instant hot oatmeal cereals

The oatmeal product of the present invention includes an oatmeal component and a vitamin C component. The oatmeal component includes processed oats, and can include other oatmeal product components. Typical components in this regard include sugar, salt, flavorings, guar gum, inclusion pieces and a vitamin and mineral blend. The vitamin C component of the product includes a triple encapsulated vitamin C component.

The oats in the oatmeal component may be processed in many ways. The whole grain may be utilized or some portion thereof. The oats may be partially cooked, pre-cooked, steam roasted or used in their raw state. A suitable oat-processing method is simply to roll the whole uncooked oats in order to obtain flat pieces. At this point, the flat oat pieces can be cut into smaller pieces if a faster cooking or instant oatmeal cereal product is desired. The oats can comprise from about 50% to 100% by weight of the oatmeal component, preferably from about 60 to about 97.5% by weight of the oatmeal component.

The oatmeal component can further include one or more sweetening agents. The sweetening agent can be a sugar and can be selected from white sugar, brown sugar, honey, molasses or any other type of natural sugar source, and combinations thereof. Such can be replaced by or used in combination with artificial sweeteners. The sweetening agent can comprise from about 0% to about 35% by weight of the oatmeal component. Many artificial sweeteners will perform satisfactorily at relatively low levels within this range.

The oatmeal component can also include salt from about 0% to about 5% by weight of the oatmeal component. Additionally, the oatmeal component can include flavorings whether artificial or natural. Typical flavorings include fruit flavors and spices such as cinnamon. The flavors can comprise from about 0% to about 5% by weight of the oatmeal component depending on the flavoring used and the flavor profile which is desired for the product.

In addition, the oatmeal component can contain a binding agent and/or a texture modification agent. For example, guar gum is typically found in cereal and cereal bar products and is used as a binding agent and to improve the mouth feel of the product. Agents of this type can be included at levels of from about 0% to about 5% by weight of the oatmeal component.

Furthermore, the oatmeal component can contain so-called inclusion pieces. Inclusion pieces as known in the art commonly refer to fruits, nuts, grains and other texture and/or nutrition enhancing products. Often these are portions of otherwise whole items. Inclusion pieces typically contained in oatmeal products include or originate from apples, bananas, berries, raisins, walnuts, and almonds, among other things. Such inclusion pieces may be included in amounts of from about 0% to about 25% by weight of the oatmeal component.

Additionally, the oatmeal component can contain a vitamin and mineral blend. Such a blend may be included at a level of from about 0% to about 5% by weight of the oatmeal component. Such can also include a blend which provides sources of vitamins and/or minerals in addition to vitamin C.

The vitamin C component is combined with the oatmeal component to make up compositions according to the invention. The vitamin C component includes a triple encapsulated vitamin C component.

The amount of vitamin C to include in an oatmeal product is more or less a matter of choice within some bounds. The U.S. Food and Drug Administration's (FDA) Recommended Daily Value (DV) of vitamin C is 60 mg. Typical oatmeal products contain from 10% DV (6 mg) of vitamin C up to 100% DV of vitamin C (60 mg). However, vitamin C is a relatively safe vitamin. Vitamin C passes easily through the body due to the fact it is water soluble. Therefore, the risk of harm of ingesting too high a level of vitamin C (less than 2 grams per day) is minimal. The range of a vitamin C component in the present invention is from about 6 mg (10% DV) to about 1000 mg (1667% DV), preferably from about 6 mg (10% DV) to about 500 mg (833% DV), more preferably from about 12 mg (20% DV) to about 250 mg (416% DV).

There are numerous vitamin C components that may be used in the present invention. The most common are ascorbic acid and salts of ascorbic acid. Of the ascorbic acid salts the preferable salts are the alkali earth metal salts of ascorbic acid. The most preferable of the salts of ascorbic acid are sodium, potassium and calcium ascorbate.

The choice of which triple encapsulated vitamin C component to incorporate into the oatmeal product is dependent on a number of factors one of which is the final taste or flavor characteristic to be expressed by the final oatmeal product. It has been determined by informal taste testing that triple encapsulated ascorbic acid may impart a slightly altered flavor to highly sweetened oat products as opposed to triple encapsulated sodium ascorbate. However, with regards to less sweetened oatmeal products, the differences between ascorbic acid and sodium ascorbate were less pronounced.

Regarding the triple encapsulation which is practiced according to the invention, layers of an oil/fat constituent and a polymer constituent are used to form the encapsulation, preferably two coatings of an oil/fat constituent and one coating of a polymer constituent. An oil/fat coating may provide the first encapsulation layer followed by a polymer coating and then a final oil/fat coating to complete the triple encapsulation. The oil/fat used should be solid at room temperature and should have a melting point of no less than 30° C., preferably not less than 60° C. Hydrogenated oil/fats such as hydrogenated vegetable oil, hydrogenated beef tallow, and hydrogenated fish oil, solid fats such as lard, and cacao butter, and synthetic solid glycerides or mixtures thereof are typical examples of oil/fats which are solid at room temperature. The preferred oil/fat constituent is hydrogenated vegetable oil.

A polymer is used as the other constituent of the triple encapsulation. Examples of such polymers include cellulose derivatives, acrylic polymers and polyvinyl acetal compounds and mixtures thereof. The preferred polymer constituent is ethyl cellulose.

A preferred triple encapsulated vitamin C component which is commercially available is characterized as a white to off-white, relatively free flowing material with some soft agglomerates that disperse with conventional mixing. At least 98% of the material can pass through a 20 U.S. Standard Sieve (850 micrometers). Each gram of this material contains about 500 mg of ascorbic acid in an edible matrix of partially hydrogenated vegetable oil and ethyl cellulose. It has a neutral to slightly sour/bitter taste and exhibits either no odor or a neutral odor.

Referring further to the possible inclusion of the vitamin and mineral blend within the oatmeal component, this is considered to be useful for adding minerals as well as vitamins in addition to vitamin C. Vitamins and mineral which do not suffer the degradation characteristics of vitamin C need not be encapsulated. If however, for any reason it is desirable, the other vitamins and minerals can be included in an encapsulated form. Examples of these minerals and other vitamins are calcium, iron, zinc, vitamin A, vitamin E and B vitamins among others.

The order of addition of the ingredients is not critical as long as the vitamin C component is adequately mixed to ensure even distribution through the product. A typical oatmeal product of the present invention is prepared by first combining the triple encapsulated vitamin C component with the other vitamin and mineral blend (when provided) and then further combining this mixture with any remaining ingredients, if used, except for the oats to create a final blend. This final blend is gravimetrically fed into the packaging container at the same time the processed oats are added.

Such an oatmeal product is typically prepared by cooking it in a boiling liquid such as milk or water as opposed to baking which is a different process.

### EXAMPLE

Two hot oatmeal cereal products of the present invention were tested to determine the level of degradation of the triple encapsulated vitamin C component over several months and if any differences in degradation existed between vitamin C components. The first hot oatmeal product contained triple encapsulated ascorbic acid, while the other contained triple encapsulated sodium ascorbate.

The analysis of the vitamin C component was carried out using an iodine-iodide titration method with a 2% starch indicator solution containing sodium azide. A known quantity of ascorbic acid standard was diluted in 1.0% oxalic acid to create a known concentration standard which was used to standardize the approximately 0.01N iodine-iodide titration solution before each day of titration analysis. A titration factor of the iodine-iodide solution was calculated as follows:
Factor=Weight of Ascorbic Acid Standard/Volume of iodine−iodide solution
Once this factor was calculated the testing of the samples proceeded as follows.

100 grams (g) of the oatmeal products were accurately weighed and placed in Erlenmeyer flasks. Before the titration analysis could be performed, the encapsulation coating the vitamin C component was removed to ensure that the vitamin C component fully dissolves in solution. 50 milliliters (mL) of methanol were added to the flasks containing the 100 g samples and the mixtures were boiled until 10 mL of methanol remained. These remaining solutions were diluted with 30 mL of the 1.0% oxalic acid solution. The solutions were titrated with the standardized iodine-iodide solution to an end-point using a few drops of the starch indicator solution. The final calculation used to determine the amount of vitamin C component was as follows:
Vitamin C component (mg)=Factor×volume (mL) of iodine−iodide solution used.

The target starting level of vitamin C component was 150 mg per 100 grams of oatmeal product. The levels of vitamin C component per 100 grams of oatmeal product are shown in the following table:

| | TRIPLE | TRIPLE |
|---|---|---|
| | ENCAPSULATED | ENCAPSULATED |
| TIME | ASCORBIC ACID | SODIUM ASCORBATE |
| Initial (0 Time) | 153 mg | 158 mg |
| 1 Month* | 61.7 mg | 122 mg |
| 2 Months* | 59.6 mg | 119 mg |
| 3 Months* | 56.7 mg | 116 mg |
| 4 Months | 159 mg | 157 mg |
| 5 Months | 157 mg | 161 mg |
| 7 Months | 168 mg | 172 mg |
| 8 Months | 128 mg | 157 mg |
| 9 Months | 155 mg | 157 mg |
| 10 Months | 172 mg | 181 mg |
| 11 Months | 144 mg | 150 mg |
| 12 Months | 195 mg | 157 mg |

*Samples analyzed during these time periods omitted the step of removing the triple encapsulation coating.

The results indicate that both the triple encapsulated ascorbic acid and the triple encapsulated sodium ascorbate did not suffer any significant degradation over a twelve month period while incorporated in the oatmeal product and exposed to normal storage conditions.

Although this invention has been described in terms of certain preferred compositions other embodiments that may be apparent to those skilled in the art are also within the scope of this invention. Accordingly, the scope of the invention is intended to be determined by reference to the appended claims.

1. An oatmeal composition comprising:
an oatmeal component having from about 50% to about 100% by weight of processed oats, based on the total weight of the oatmeal component; and
a vitamin C component having from about 6 mg to about 1000 mg of a triple encapsulated vitamin C component selected from the group consisting of triple encapsulated ascorbic acid and triple encapsulated salts of ascorbic acid.

2. The oatmeal composition as in claim 1, wherein said processed oats comprises from about 60% to about 97.5% by weight, based upon the total weight of the oatmeal component.

3. The oatmeal composition as in claim 1, wherein said triple encapsulated vitamin C component comprises from about 6 mg to about 500 mg of the composition.

4. The oatmeal composition as in claim 1, wherein said triple encapsulated vitamin C component comprises from about 12 mg to about 250 mg of the composition.

5. The oatmeal composition as in claim 1, wherein said triple encapsulated vitamin C component is triple encapsulated ascorbic acid.

6. The oatmeal composition as in claim 1, wherein said triple encapsulated vitamin C component is an alkali earth metal salt of ascorbic acid which has been triple encapsulated.

7. The oatmeal composition as in claim 6, wherein said triple encapsulated vitamin C component is triple encapsulated sodium ascorbate.

8. The oatmeal composition as in claim 6, wherein said triple encapsulated vitamin C component is triple encapsulated potassium ascorbate.

9. The oatmeal composition as in claim 6, wherein said triple encapsulated vitamin C component is triple encapsulated calcium ascorbate.

10. The oatmeal composition as in claim 1, wherein said triple encapsulated vitamin C component comprises at least one vegetable oil coating and at least one ethyl cellulose coating.

11. The oatmeal composition as in claim 1, wherein said triple encapsulated vitamin C component comprises two vegetable oil coatings and one ethyl cellulose coating.

12. The oatmeal composition as in claim 11, wherein said ethyl cellulose coating is between said two vegetable oil coatings.

13. The oatmeal composition as in claim 11, wherein said two vegetable oil coatings are of the same vegetable oil compound.

14. The oatmeal composition as in claim 11, wherein said two vegetable oil coatings are of different vegetable oil compounds.

15. An oatmeal composition comprising:
an oatmeal component including:
from about 50% to about 100% by weight processed oats;
from about 0% to about 35% by weight sweetener;
from about 0% to about 5% by weight salt; and
from about 0% to about 5% of a vitamin and mineral blend, each % by weight being based upon the total weight of the oatmeal component; and
a vitamin C component including:
from about 6 mg to about 1000 mg of a triple encapsulated vitamin C component selected from the group consisting of triple encapsulated ascorbic acid and triple encapsulated salts of ascorbic acid.

16. The oatmeal composition as in claim 15, wherein said oatmeal component further includes from about 0% to about 5% by weight of flavorings, based on the total weight of the oatmeal component.

17. The oatmeal composition as in claim 15, wherein said oatmeal component further includes from about 0% to about 5% by weight of a binding agent or texture modifying agent, based on the total weight of the oatmeal component.

18. The oatmeal composition as in claim 15, wherein said oatmeal component further includes from about 0% to about 25% by weight of inclusion pieces, based on the total weight of the oatmeal component.

19. The oatmeal composition as in claim 15, wherein said oatmeal component further includes:
from about 0% to about 5% by weight of flavorings, based on the total weight of the oatmeal component;
from about 0% to about 5% by weight of a binding agent or texture modifying agent, based on the total weight of the oatmeal component; and
from about 0% to about 25% by weight of inclusion pieces, based on the total weight of the oatmeal component.

20. The oatmeal composition as in claim 15, wherein said processed oats comprises from about 60 to about 97.5% by weight, based upon the total weight of the oatmeal component.

21. The oatmeal composition as in claim 15, wherein said triple encapsulated vitamin C component comprises from about 6 mg to about 500 mg.

22. The oatmeal composition as in claim 15, wherein said triple encapsulated vitamin C component comprises from about 12 mg to about 250 mg.

23. The oatmeal composition of claim 15, wherein said sweetener comprises from about 5% to about 30% by weight of the oatmeal component.

24. The oatmeal composition of claim 15, wherein said salt comprises from about 0.5% to about 4.5% by weight of the oatmeal component.

25. The oatmeal composition of claim 16, wherein said flavorings comprise from about 0.5% to about 4.5% by weight of the oatmeal component.

26. The oatmeal composition of claim 17, wherein said binding agent or texture modifying agent is a gum which comprises from about 0.5% to about 4.5% by weight of the oatmeal component.

27. The oatmeal composition of claim 18, wherein said inclusion pieces comprise from about 3% to about 25% by weight of the oatmeal component.

28. The oatmeal composition of claim 27, wherein said inclusion pieces are selected from the group consisting of fruit originating materials and nut originating materials.

29. The oatmeal composition of claim 15, wherein said vitamin and mineral blend comprises from about 0.1% to about 3% by weight of the oatmeal composition.

30. The oatmeal composition of claim 29, wherein said vitamin and mineral blend excludes a vitamin C component.

31. The oatmeal composition as in claim 15, wherein said triple encapsulated vitamin C component is triple encapsulated ascorbic acid.

32. The oatmeal composition as in claim 15, wherein said triple encapsulated vitamin C component is a triple encapsulated alkali earth metal salt of ascorbic acid.

33. The oatmeal composition as in claim 32, wherein said triple encapsulated vitamin C component is triple encapsulated sodium ascorbate.

34. The oatmeal composition as in claim 32, wherein said triple encapsulated vitamin C component is triple encapsulated potassium ascorbate.

35. The oatmeal composition as in claim 32, wherein said triple encapsulated vitamin C component is triple encapsulated calcium ascorbate.

36. The oatmeal composition as in claim 15, wherein said triple encapsulated vitamin C component comprises at least one vegetable oil coating and at least one ethyl cellulose coating.

37. The oatmeal composition as in claim 36, wherein said triple encapsulated vitamin C component comprises two vegetable oil coatings and one ethyl cellulose coating.

38. The oatmeal composition as in claim 37, wherein said ethyl cellulose coating is between said two vegetable oil coatings.

39. The oatmeal composition as in claim 37, wherein said two vegetable oil coatings are of the same vegetable oil compound.

40. The oatmeal composition as in claim 37, wherein said two vegetable oil coatings are of different vegetable oil compounds.

41. An oatmeal composition comprising:
an oatmeal component having from about 50% to about 100% by weight processed oats, based on the total weight of the oatmeal component; and
a vitamin C component having from about 10% to about 1667% of the recommended daily allowance of a vitamin C component selected from the group consisting of ascorbic acid and salts of ascorbic acid which has been triple encapsulated.

42. The oatmeal composition as in claim 41, wherein said processed oats comprises from about 60% to about 97.5% by weight, based upon the total weight of the oatmeal component.

43. The oatmeal composition as in claim 41, wherein said vitamin C component comprises from about 10% to about 833% of the recommended daily value of a vitamin C component which has been triple encapsulated.

44. The oatmeal composition as in claim 41, wherein said vitamin C component comprises from about 20% to about 417% of the recommended daily value of a vitamin C component which has been triple encapsulated.

45. The oatmeal composition as in claim 41, wherein said triple encapsulated vitamin C component is triple encapsulated ascorbic acid.

46. The oatmeal composition as in claim 41, wherein said triple encapsulated vitamin C component is an alkali earth metal salt of ascorbic acid which has been triple encapsulated.

47. The oatmeal composition as in claim 46, wherein said triple encapsulated vitamin C component is triple encapsulated sodium ascorbate.

48. The oatmeal composition as in claim 46, wherein said triple encapsulated vitamin C component is triple encapsulated potassium ascorbate.

49. The oatmeal composition as in claim 46, wherein said triple encapsulated vitamin C component is triple encapsulated calcium ascorbate.

50. The oatmeal composition as in claim 41, wherein said triple encapsulated vitamin C component comprises a vegetable oil coating and an ethyl cellulose coating.

51. The oatmeal composition as in claim 41, wherein said triple encapsulated vitamin C component comprises two vegetable oil coatings and one ethyl cellulose coating.

52. The oatmeal composition as in claim 51, wherein said ethyl cellulose coating is between said two vegetable oil coatings.

53. The oatmeal composition as in claim 51, wherein said two vegetable oil coatings are of the same vegetable oil compound.

54. The oatmeal composition as in claim 51, wherein said two vegetable oil coatings are of different vegetable oil compounds.
